(19) United States
(12) Patent Application Publication
(10) Pub. No.: US 2005/0111906 A1
(43) Pub. Date: May 26, 2005

(54) Fixable rotary base

(76) Inventors: Wun-Chun Liou, Taipei (TW); Chao-Chi Huang, Taipei (TW)

Correspondence Address: Raymond Sun, 12420 Woodhall Way, Tustin, CA, 92782, US

(21) Appl. No.: 10/889,989

(22) Filed: Jul. 12, 2004

(30) Foreign Application Priority Data
Nov. 21, 2003 (TW) 92220560

(51) Int. Cl. F16D 1/12

(52) U.S. Cl. 403/120

(57) ABSTRACT

A fixable rotary base can be fixed at one of a plurality of positions at different angles. The rotary base includes a bushing having a cylindrical ring and a locking element disposed at the circumference of the ring, and a circular buckle having a circular body and a plurality of grooves disposed along the circumference of the circular body. The locking element is seated in one of the grooves when the bushing couples the buckle.

### BACKGROUND OF THE INVENTION

1. Field of the Invention

The present invention relates to rotary bases, and in particular, to a fixable rotary base.

2. Description of the Prior Art

There are numerous types of protective covers, but the common one is the mobile phone cover. Given the increased worldwide use of mobile phones, the demand for mobile phone covers is increasing accordingly. At present, most protective covers (including mobile phone covers) allow the carrying object to hang down naturally. Thus, the protection provided by such protective covers is insufficient for certain situations.

FIG. 1A illustrates a conventional mobile phone cover module 100, and FIG. 1B is a side-view diagram of the module 100 of FIG. 1A. The conventional mobile phone cover module 100 comprises a dash mount 102, a swivel lock 104, a press tab 106, a rear plate 108 and a resilient member 110, and can be used to hold a mobile phone. The dash mount 102 has a groove 112, with the circumference of a circular notch 118 at one end of the groove 112 being larger than the width of the groove 112. The resilient member 110 is coupled to both the dash mount 102 and the back plate 108, and the press tab 106 is coupled to the swivel lock 104.

FIG. 1C illustrates a circular buckle at the back of a conventional mobile phone cover 101. A circular buckle 114 is disposed at the back of the mobile phone cover 101, and a hole 116 is disposed at the center of the circular buckle 114. The hole 116 is large enough to accommodate the swivel lock 104. If the back plate 108 is pressed at the end proximate the resilient member 110, then the back plate 108 can be detached from the dash mount 102. After the back plate 108 is released, the dash mount 102 and the back plate 108 clamp the belt at the waist. If a user wants to carry a mobile phone by means of the mobile phone cover 101, the user can slide the circular buckle 114 at the back of the mobile phone cover 101 along the groove 112 of the dash mount 102. When the circular buckle 114 passes through the swivel lock 104, the swivel lock 104 will be pressed down and drawn backward. When the hole 116 passes through the swivel lock 104, the swivel lock 104 will bounce to be locked into the hole 116. The circular buckle 114 is then mounted into the circular notch 118. If the user wants to remove the mobile phone cover 101 from the mobile phone cover module 100, the user can press the press tab 106 down, so that the swivel lock 104 will be drawn back and separated from the hole 116, thereby removing the circular buckle 104 from the groove 112.

Unfortunately, the use of this conventional mobile phone cover 101 and cover module 100 is inconvenient for the following reasons:

1. After the mobile phone cover 101 and cover module 100 are combined, the mobile phone and its cover can be rotated by 360 degrees, but cannot be secured in a fixed position. The mobile phone can only be hung down naturally, but cannot be fixed into positions at different angles.

2. If the mobile phone cover 101 contains other objects, then the objects must be taken out from the cover 101 before it can be used with a mobile phone. Thus, such objects cannot be used directly at the position where they are located.

### SUMMARY OF THE INVENTION

It is an object of the present invention to provide a rotary base that can be fixed at a plurality of positions at different angles.

In order to achieve the objectives of the present invention, there is provided a fixable rotary base and a device for fixing the rotary base. The rotary base can be fixed at one of a plurality of positions at different angles. The rotary base includes a bushing having a cylindrical ring and a locking element disposed at the circumference of the ring, and a circular buckle having a circular body and a plurality of grooves disposed along the circumference of the circular body. The locking element is seated in one of the grooves when the bushing couples the buckle.

The bushing can be coupled to a first loading base, and the buckle can be coupled to a second loading base which carries an object. The first loading base can be used and worn at different parts of a human body, and the object can be used at its original position without removing it from the second loading base that is coupled to the buckle of the rotary base.

### BRIEF DESCRIPTION OF THE DRAWINGS

FIG. 1A is a front view of conventional mobile phone cover module.

FIG. 1B is a side view of the module of FIG. 1A.

FIG. 1C is a side view of a circular buckle at the back of a conventional mobile phone cover.

FIG. 2A is a perspective view of the circular buckle of a fixable rotary base according to one embodiment of the present invention.

FIG. 2B is a perspective view of the bushing of a fixable rotary base according to one embodiment of the present invention.

FIG. 2C is a side plan view of the support member of the bushing of the fixable rotary base of FIG. 2B.

FIG. 3 is a perspective view of a fixable rotary base according to another embodiment of the present invention.

FIG. 4 illustrates how the fixable rotary base of the present invention is used.

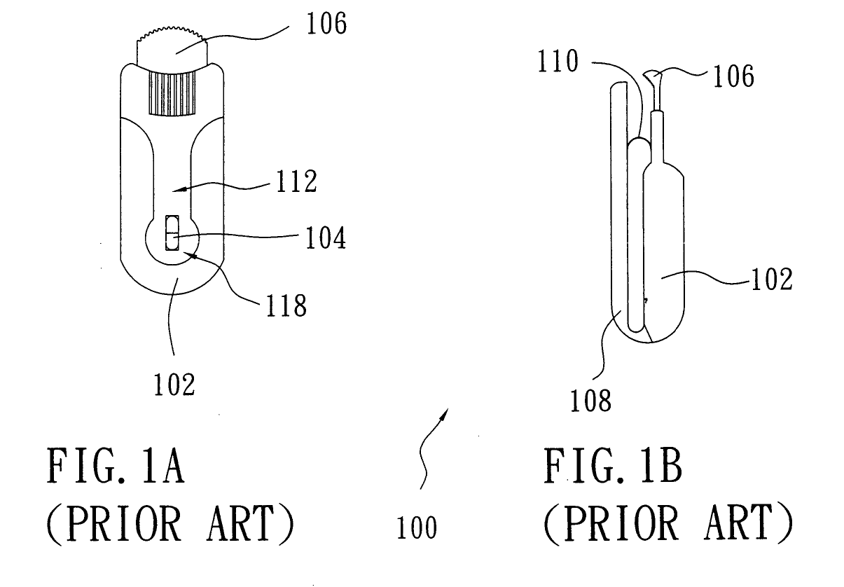

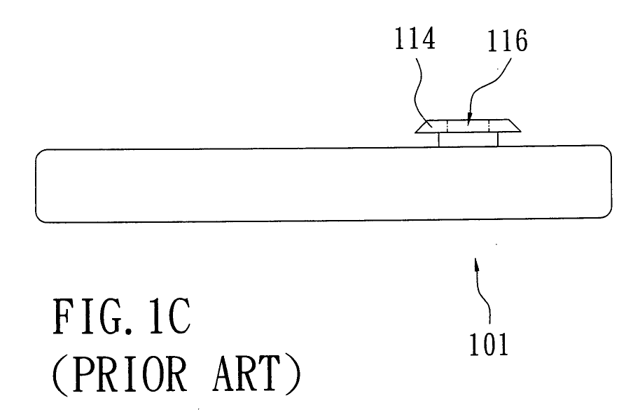

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

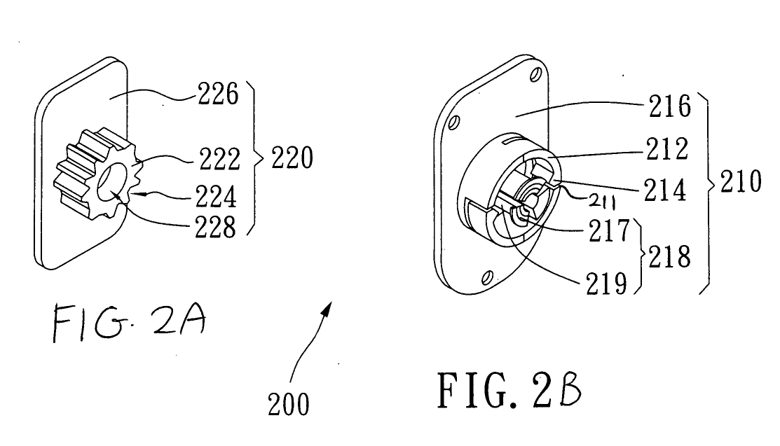

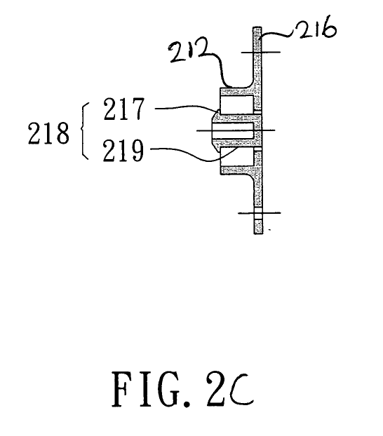

FIGS. 2A-2C illustrate a fixable rotary base 200 according to one embodiment of the present invention. The rotary base 200 has a bushing 210 and a circular buckle 220. Referring to FIGS. 2B and 2C, the bushing 210 has a cylindrical ring 212 provided on a first fixed base 216, and the ring 212 has at least one locking element 214 provided at its internal circumference. The locking element 214 can be a swivel lock provided in the form of a protruding bar. The bushing 210 further includes at least one support member 218 which is in the shape of a curved bar. The support member 218 has a first end 217 and a second end 219, with the second end 219 extending from the first fixed base 216. The first end 217 is larger than the second end 219. The support member 218 is disposed inside the ring 212. The bushing 210 is made of a strong material having wear-resistant and elastic properties, such as but not limited to polypropylene, butadiene, styrene, polycarbonate resin, or their combinations. The bushing 210 can be manufactured using well-known injection molding processes.

Referring to FIG. 2A, the circular buckle 220 has a circular body 222 extending from a second fixed base 226. The circular body 222 has an internal bore 228, and a plurality of grooves 224 provided along the external circumference of the circular body 222. When the circular buckle 220 is connected to the bushing 210, the lock 214 of the bushing 210 is locked into one of the grooves 224 of the circular buckle 220, and the support member 218 is inserted into the internal bore 228. The larger first end 217 of the support member 218 is biased outwardly inside the internal bore 228 against the circular body 222 such that the bushing 210 and the circular buckle 220 are coupled securely to each other.

The circular buckle 220 can be made of a material having a wear-resistant property such as polypropylene, butadiene, styrene, polycarbonate resin, or their combinations, which can withstand the friction caused by the rotation of the bushing 210 over a long period of time. The circular buckle 220 can be manufactured using well-known injection molding processes.

The first fixed base 216 and the second fixed base 226 can be made of metal, or of the same material as that of the bushing 210 and the circular buckle 220. The ring 212 and the circular body 222 can be made in one piece with the first fixed base 216 and the second fixed base 226, respectively, using well-known injection molding processes.

In addition, one or more cut-outs or gaps 211 are provided in the ring 212. For example, a gap 211 can be provided adjacent the lock 214, so that a user applying a force onto the first fixed base 216 or the second fixed base 226 will cause the lock 214 to change its position from one groove 224 to an adjacent groove 224, thereby allowing the bushing 210 and the circular buckle 220 to rotate with respect to each other. In other words, a gap 211 is provided in the ring 212 proximate the lock 214 so that the bushing 210 and the circular buckle 220 not only can connect with each other easily, but also can rotate with respect to each other easily. Further, additional grooves 224 can be provided on the circular body 222, so that the circular buckle 220 can be fixed into a variety of different angular positions.

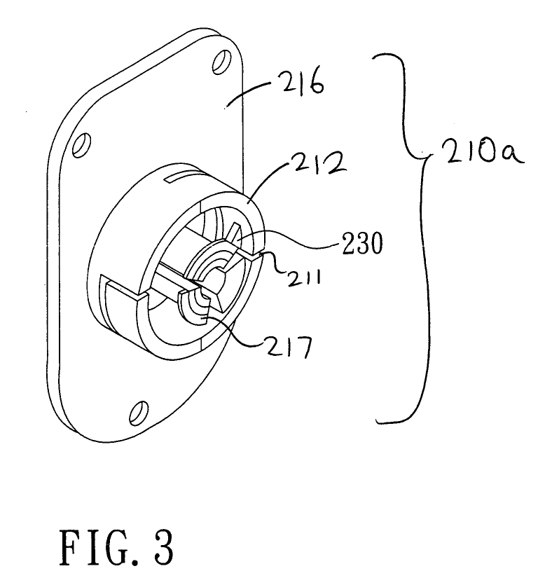

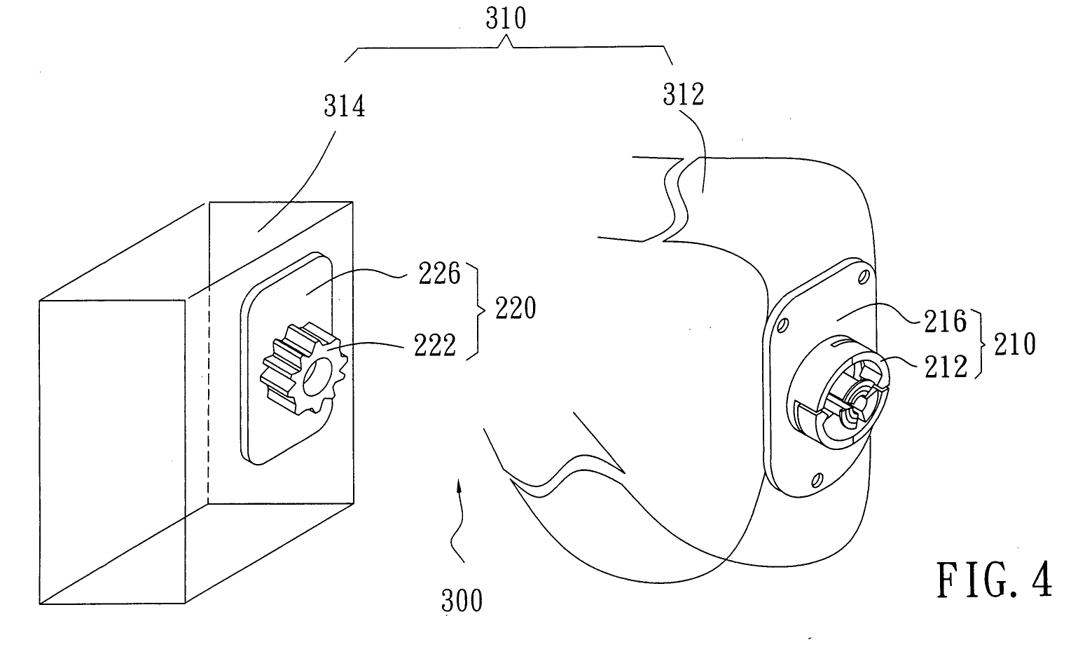

FIG. 3 illustrates a bushing 210a according to another embodiment of the present invention. The bushing 210a in FIG. 4 is the same as the bushing 210 in FIG. 2B, except that the locking element 230 is in the shape of a protruding point. Otherwise, the elements 211a, 212a, 216a and 217a are the same as the elements 211, 212, 216 and 217 in FIG. 2B.

FIG. 4 illustrates how the fixable rotary base 200 of FIGS. 2A-2C can be used with an apparatus 300. The apparatus 300 has a loading device 310, a bushing 210, and a circular buckle 220, which are adapted for carrying an object. The loading device 310 has a first loading base 312 and a second loading base 314. The first loading base 312 is coupled to the first fixed base 216 of the bushing 210, and the second loading base 314 is coupled to the second fixed base 226 of the circular buckle 220. The bushing 210 and the circular buckle 220 can be the same as those described above in FIGS. 2A-2C, and thus will not be described in greater detail here. In FIG. 4, the first loading base 312 is worn or hung on the waist, wrist or leg, and the second loading base 314 has an enclosure (see FIG. 4) or connector that can carry objects such as a mobile phone, a flashlight, a handgun, a protective rod, a kettle, or a sword. The shape of the second loading base 314 can vary depending on the shape of these objects.

Thus, the present invention provides at least one lock 214 or 230 of a ring 212 that is adapted to be disposed in the groove 224 of the circular body 222, such that the lock 214, 230 can change its position from one groove 224 to another. As a result, it can also change the position of the carrying object.

Numerous alternatives and modifications can be made without departing from the scope of the present invention. For example, the shapes of the bushing 210 and the circular buckle 220 can be varied. Similarly, the grooves 224 can be provided on the internal bore 228 of the circular body 222, so that the first end 217 of the support member 218 can be disposed in one of the grooves 224.

In summary, the fixable rotary base and the apparatus of the present invention has at least the following advantages:

1. The fixable rotary base according to the present invention can change the position of the carrying object, and can fix the carrying object without being limited to certain specific angles.

2. The fixable rotary base according to the present invention can be manufactured using injection molding processes, thereby lowering the production cost and facilitating mass production.

3. The fixable rotary base according to the present invention is easy and convenient to use because it only requires the user to pull the circular buckle 220 out of the bushing 210 to separate the first loading base 312 and the second loading base 314.

While the description above refers to particular embodiments of the present invention, it will be understood that many modifications may be made without departing from the spirit thereof. The accompanying claims are intended to cover such modifications as would fall within the true scope and spirit of the present invention.

1. A fixable rotary base, comprising:
a bushing having a cylindrical ring and a locking element disposed at the circumference of the ring; and
a circular buckle having a circular body and a plurality of grooves disposed along the circumference of the circular body, such that the locking element is seated in one of the grooves when the bushing couples the circular buckle.

2. The base of claim 1, wherein the circular body is disposed inside the ring when the bushing couples the circular buckle.

3. The base of claim 1, wherein the bushing further includes a first fixed base and a support member, with the ring and the support member coupled to the first fixed base, and with the support member disposed within the ring, and wherein the support member comprises a first end and a second end, with the first end being larger than the second end.

4. The base of claim 3, wherein the circular buckle further includes a second fixed base that is coupled to the circular body, with the circular body having a bore, and wherein the support member is inserted into the bore of the circular body, so that the bushing and the circular buckle are secured together by pressing the first end of the support member against the internal circumference of the bore of the circular body.

5. The base of claim 4, wherein the locking element is moved from one groove to another groove by rotating one of the first fixed base or the second fixed base.

6. The base of claim 5, wherein the first and second fixed bases are made of a material selected from metal, polypropylene, butadiene, styrene, polycarbonate resin, and their combinations.

7. The base of claim 1, wherein the circular ring has a gap provided adjacent the locking element.

8. The base of claim 1, wherein the locking element comprises a protruding bar.

9. The base of claim 1, wherein the bushing and the circular buckle are manufactured by an injection molding process.

10. The base of claim 1, wherein the locking element is disposed at the internal circumference of the ring, and the plurality of grooves are disposed along the external circumference of the circular body.

11. An apparatus having a fixable rotary base, comprising:
a loading device having a first loading base and a second loading base;
a bushing coupled to the first loading base, the bushing having a cylindrical ring and a locking element disposed at the circumference of the ring; and
a circular buckle coupled to the second loading base, the circular buckle having a circular body and a plurality of grooves disposed along the circumference of the circular body, such that the locking element is seated in one of the grooves when the bushing couples the circular buckle.

12. The apparatus of claim 11, wherein the bushing further includes a first fixed base and a support member, with the ring and the support member coupled to the first fixed base, and with the support member disposed within the ring, and wherein the support member comprises a first end and a second end, with the first end being larger than the second end.

13. The apparatus of claim 12, wherein the circular buckle further includes a second fixed base that is coupled to the circular body, with the circular body having a bore, and wherein the support member is inserted into the bore of the circular body, so that the bushing and the circular buckle are secured together by pressing the first end of the support member against the internal circumference of the bore of the circular body.

14. The apparatus of claim 13, wherein the locking element is moved from one groove to another groove by rotating one of the first fixed base or the second fixed base.

15. The apparatus of claim 13, wherein the first and second fixed bases are made of a material selected from metal, polypropylene, butadiene, styrene, polycarbonate resin, and their combinations.

16. The apparatus of claim 11, wherein the circular ring has a gap provided adjacent the locking element.

17. The apparatus of claim 11, wherein the locking element comprises a protruding bar.

18. The apparatus of claim 11, wherein the bushing and the circular buckle are manufactured by an injection molding process.

19. The apparatus of claim 11, wherein the first loading base has a shape which corresponds to a human waist, wrist, or a leg.

20. The apparatus of claim 11, wherein the second loading base has means for retaining an object.

21. The apparatus of claim 11, wherein the locking element is disposed at the internal circumference of the ring, and the plurality of grooves are disposed along the external circumference of the circular body.
